(19) United States
(12) Patent Application Publication
(10) Pub. No.: US 2025/0336597 A1
(43) Pub. Date: Oct. 30, 2025

(54) COIL COMPONENT

(71) Applicant: TDK Corporation, Tokyo (JP)

(72) Inventors: Makoto HIRAKI, Tokyo (JP); Toshio TOMONARI, Tokyo (JP); Shoma KAJIKIYA, Tokyo (JP); Chris T. BURKET, Lincolnshire, IL (US)

(73) Assignee: TDK Corporation, Tokyo (JP)

(21) Appl. No.: 19/171,484

(22) Filed: Apr. 7, 2025

Related U.S. Application Data
(60) Provisional application No. 63/575,175, filed on Apr. 5, 2024.
(60) Provisional application No. 63/575,178, filed on Apr. 5, 2024.

(51) Int. Cl. H01F 27/38; H01F 5/04; H01F 5/06; H01F 17/04; H01F 27/00; H01F 38/14; H01Q 7/06

(52) U.S. Cl. CPC H01F 27/38; H01F 5/04; H01F 5/06; H01F 17/04; H01F 27/006; H01F 38/14; H01F 2038/143; H01Q 7/06

(57) ABSTRACT

Disclosed herein is a coil component that includes a first coil wound about a first coil axis, a second coil having one end connected to one end of the first coil and wound about a second coil axis, and a third coil having one end connected to the other end of the first coil and wound about a third coil axis. The line lengths of both the second and third coils are shorter than the line length of the first coil, and the inside area of the second coil and the inside area of the third coil do not overlap each other.

### CROSS-REFERENCE TO RELATED APPLICATION

This application claims the benefit of U.S. Patent Provisional Applications No. 63/575,175 and No. 63/575,178, filed on Apr. 5, 2024, the entire disclosures of which are incorporated by reference herein.

### BACKGROUND

The present disclosure relates to a coil component.

JP 2018-023091A discloses a coil component that functions an antenna for near-field communication (NFC).

Coil components of such a type are sometimes added with an electronic component such as a chip inductor so as to ensure isolation from an unnecessary frequency component. This, however, increases the number of components.

### SUMMARY

A coil component according to an aspect of the present disclosure includes: a first coil wound about a first coil axis; a second coil having one end connected to one end of the first coil and wound about a second coil axis; and a third coil having one end connected to the other end of the first coil and wound about a third coil axis. The line lengths of both the second and third coils are shorter than the line length of the first coil, and the inside area of the second coil is positioned outside the inside area of the third coil as viewed in the axial direction of the second coil.

### BRIEF DESCRIPTION OF THE DRAWINGS

The above features and advantages of the present disclosure will be more apparent from the following description of some embodiments taken in conjunction with the accompanying drawings, in which:

FIG. 1 is a schematic plan view illustrating the outer appearance of a coil component 100 according to a first embodiment of the technology described herein;

FIG. 2 is a schematic plan view illustrating the outer appearance of the coil component 100 viewed from the opposite side of FIG. 1;

FIG. 3 is a schematic cross-sectional view of the coil component 100;

FIG. 4 is a schematic cross-sectional view of a coil component 200 according to a second embodiment of the technology described herein;

FIG. 5 is a schematic plan view illustrating the outer appearance of the coil component 200;

FIG. 6 is a schematic cross-sectional view of a coil component 300 according to a third embodiment of the technology described herein;

FIG. 7 is a schematic cross-sectional view of a coil component 400 according to a fourth embodiment of the technology described herein;

FIG. 8 is a schematic plan view illustrating the outer appearance of a coil component 500 according to a fifth embodiment of the technology described herein;

FIG. 9 is a schematic plan view illustrating the outer appearance of the coil component 500 viewed from the opposite side of FIG. 8;

FIG. 10 is a schematic plan view illustrating the outer appearance of a coil component 600 according to a sixth embodiment of the technology described herein;

FIG. 11 is a schematic cross-sectional view of a coil component 700 according to a seventh embodiment of the technology described herein;

FIG. 12 is a schematic cross-sectional view of a coil component 800 according to an eighth embodiment of the technology described herein;

FIG. 13 is a schematic cross-sectional view of a coil component 900 according to a ninth embodiment of the technology described herein;

FIG. 14 is a schematic cross-sectional view of a coil component 1000 according to a tenth embodiment of the technology described herein;

FIG. 15 is a schematic plan view illustrating the outer appearance of a coil component 1100 according to an eleventh embodiment of the technology described herein; and

FIG. 16 is a graph illustrating the characteristics of the coil component 1100 according to the eleventh embodiment.

### DETAILED DESCRIPTION OF THE EMBODIMENTS

The present disclosure describes a coil component capable of ensuring isolation from an unnecessary frequency component without adding an electronic component such as a chip inductor.

Hereinafter, embodiments of the technology according to the present disclosure will be described in detail with reference to the accompanying drawings.

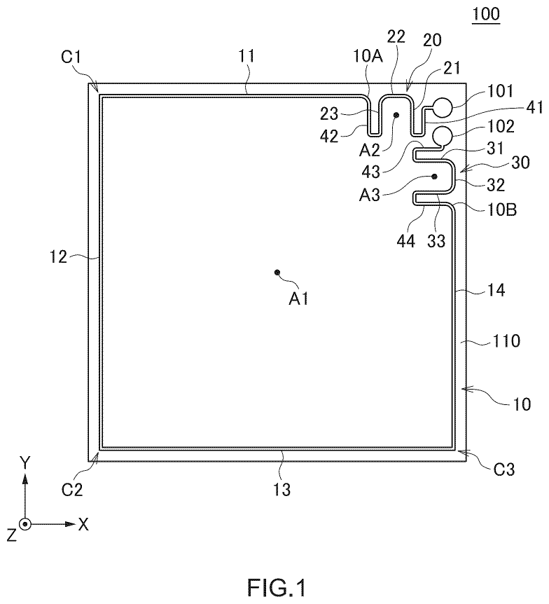

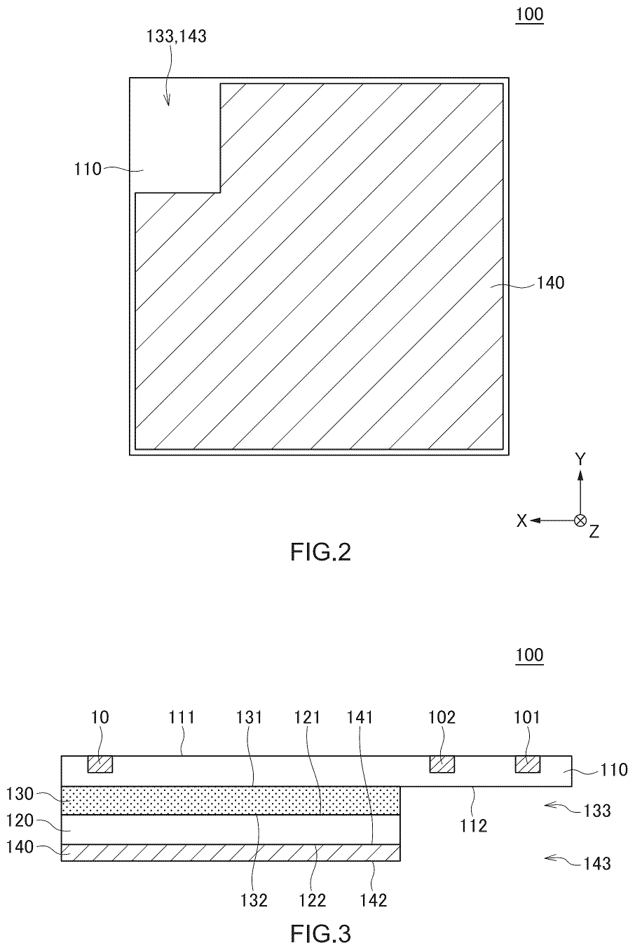

FIGS. 1 and 2 are schematic plan views each illustrating the outer appearance of a coil component 100 according to a first embodiment of the technology described herein, which illustrate the structure as viewed from the opposite sides. FIG. 3 is a schematic cross-sectional view of the coil component 100.

As illustrated in FIGS. 1 to 3, the coil component 100 according to the first embodiment includes a first resin layer 110, a magnetic body 130, a second resin layer 120, and a metal layer 140 which are stacked in this order and first, second, and third coils 10, 20, and 30 which are embedded on the side of one surface 111 of the first resin layer 110. The first, second, and third coils 10, 20, and 30 may each be made of a low resistance material such as copper or aluminum. It is not essential that the first, second, and third coils 10, 20, and 30 are embedded in the first resin layer 110; however, embedding these coils in the first resin layer 110 can enhance the surface flatness of the coil component 100 and reduce the entire thickness thereof. Further, it is also not essential that the first, second, and third coils 10, 20, and 30 are each entirely embedded in the first resin layer 110, but they may be partially exposed from the first resin layer 110. In the example illustrated in FIG. 3, the surfaces of the first, second, and third coils 10, 20, and 30 positioned on the opposite side of the surfaces thereof facing the magnetic body 130 are exposed from the first resin layer 110.

The first resin layer 110 is positioned between the first to third coils 10 to 30 and the magnetic body 130 so as to be sandwiched therebetween. The other surface 112 of the first resin layer 110 is bonded to one surface 131 of the magnetic body 130. The first resin layer 110 may contain inorganic filler particles and a binder resin. Using a material containing inorganic filler particles for the first resin layer 110 increases the strength of the first resin layer 110.

The material of the inorganic filler particles contained in the first resin layer 110 may be a nonmagnetic inorganic material such as alumina, aluminum hydroxide, talc, magnesium hydroxide, silica, calcium carbonate, barium titanate, zirconium titanate, or zinc zirconate titanate.

Examples of the material of the binder resin contained in the first resin layer 110 include acrylic resin, polyester resin, polyethylene resin, polyvinyl chloride resin, polyvinyl butyral resin, poly urethane resin, polyester urethane resin, cellulose resin, ABS (acrylonitrile-butadiene-styrene) resin, nitrile-butadiene rubber, styrene-butadiene rubber, epoxy resin, phenol resin, amide resin, polyester elastomer, and polyamide elastomer. The elongation percentage obtained by tensile test for resin used as the binder resin may be higher than 400%.

The magnetic body 130 is disposed between the first coil 10 and the metal layer 140. This suppresses an eddy current caused due to application of magnetic flux generated by the first coil 10 to the metal layer 140. The second coil 20 overlaps a first outside area positioned outside the outer peripheral edge of the magnetic body 130 as viewed in the Z-direction, i.e., axial direction of a second coil axis A2 (to be described later) of the second coil 20), and the third coil 30 overlaps the first outside area positioned outside the outer peripheral edge of the magnetic body 130 as viewed in the Z-direction, i.e., axial direction of a third coil axis A3 (to be described later) of the third coil 30). In the present embodiment, a cutout area 133 of the magnetic body 130 is provided, as the first outside area, at a position overlapping the second and third coils 20 and 30, and thus, the second and third coils 20 and 30 do not overlap the magnetic body 130 in the Z-direction (stacking direction).

The magnetic body 130 may be a magnetic resin layer containing flat magnetic powders and a binder resin. The flat magnetic powders may be made of a metal magnetic material such as sendust, permalloy, Fe—Si—Cr-based alloy magnetic body, Fe—Si—Al—Cr-based alloy magnetic body, or Fe—Al—Cr-based alloy magnetic body. Examples of the material of the binder resin include acrylic resin, polyester resin, polyethylene resin, polyvinyl chloride resin, polyvinyl butyral resin, poly urethane resin, polyester urethane resin, cellulose resin, ABS (acrylonitrile-butadiene-styrene) resin, nitrile-butadiene rubber, styrene-butadiene rubber, epoxy resin, phenol resin, amide resin, polyester elastomer, and polyamide elastomer.

The metal layer 140 overlaps the first coil 10, whereas it has a clearance area 143 as a second outside area at a position overlapping the second and third coils 20 and 30. Thus, the second and third coils 20 and 30 do not overlap the metal layer 140 in the Z-direction (stacking direction). That is, the second coil 20 overlaps, in the Z-direction, the second outside area positioned outside the outer peripheral edge of the metal layer 140, and the third coil 30 overlaps, in the Z-direction, the second outside area. The metal layer 140 and magnetic body 130 are bonded to each other through the second resin layer 120 positioned therebetween. The second resin layer 120 may have the same configuration as that of the first resin layer 110. Further, the material of the inorganic filler particles contained in the second resin layer 120 may be a nonmagnetic inorganic material as with the first resin layer 110, or a magnetic material such as a ferrite or an Fe-based alloy magnetic body. Examples of the Fe-based alloy magnetic body include permalloy, sendust, Fe—Si—Cr, Fe—Si, carbonyl iron, Fe-based alloy amorphous powder containing at least Fe—Si—B, and Fe-based alloy nanocrystalline powder containing at least Fe—B—P—Cu. Using a magnetic material for the inorganic filler particles further increases the inductance of the first coil 10. One surface 121 of the second resin layer 120 is bonded to the other surface 132 of the magnetic body 130, the other surface 122 of the second resin layer 120 is bonded to one surface 141 of the metal layer 140. The other surface 142 of the metal layer 140 is exposed. The metal layer 140 may function as a support for increasing the mechanical strength of the coil component 100.

The first coil 10 is formed of a coil pattern largely wound about the first coil axis A1 along the outer peripheral edge of the first resin layer 110 and includes a first section 11, a second section 12, a third section 13, and a fourth section 14. The first section 11 extends in the X-direction (first direction) from one end 10A of the first coil 10 toward a first corner C1. The second section 12 extends in the Y-direction (second direction) perpendicular to the X-direction from the first corner C1 toward a second corner C2. The third section 13 extends in the X-direction from the second corner C2 toward a third corner C3. The fourth section 14 extends in the Y-direction from the third corner C3 toward the other end 10B of the first coil 10. The number of turns of the first coil 10 is less than one. Specifically, in the example illustrated in FIG. 1, the number of turns of the first coil 10 is about ⅚. The pattern width of the first coil 10 may be larger than the pattern widths of the second and third coils 20 and 30. This can reduce the resistance value of the first coil 10.

The second coil 20 is formed of a coil pattern wound about the second coil axis A2. The XY plane position of the second coil axis A2 differs from the XY plane position of the first coil axis A1. One end of the second coil 20 is connected to the one end 10A of the first coil 10 through a connection pattern 42, and the other end of the second coil 20 is connected to a first pad electrode 101 through a connection pattern 41. More specifically, the second coil 20 includes a first section 21, a second section 22, and a third section 23. The first section 21 extends in the Y-direction and has one end connected to the first pad electrode 101 through the connection pattern 41. The second section 22 extends in the X-direction and has one end connected to the other end of the first section 21. The third section 23 extends in the Y-direction and has one end connected to the other end of the second section 22 and the other end connected to the one end 10A of the first coil 10 through the connection pattern 42. The number of turns of the second coil 20 is less than one.

As described above, the second coil 20 is connected to the end portion (one end 10A) of the first section 11 of the first coil 10 that extends in the X-direction and wound by about ¾ turn so as to protrude outward in the radial direction of the first coil 10 (i.e., in the positive Y-direction). The radial direction of the first coil 10 is oriented in the XY plane direction perpendicular to the Z-direction from the first coil axis A1. Therefore, the inside area of the second coil 20 partially surrounded by the conductor pattern of the second coil 20 is connected area of the first coil 10 partially to the inside surrounded by the conductor pattern of the first coil 10 through an area where the conductor pattern of the second coil 20 is absent.

The third coil 30 is formed of a coil pattern wound about the third coil axis A3. The XY plane position of the third coil axis A3 differs from the XY plane positions of the first and second coil axes A1 and A2. One end of the third coil 30 is connected to the other end 10B of the first coil 10 through a connection pattern 44, and the other end of the third coil 30 is connected to a second pad electrode 102 through a connection pattern 43. More specifically, the third coil 30 includes a first section 31, a second section 32, and a third section 33. The first section 31 extends in the X-direction and has one end connected to the second pad electrode 102 through the connection pattern 43. The second section 32 extends in the Y-direction and has one end connected to the other end of the first section 31. The third section 33 extends in the X-direction and has one end connected to the other end of the second section 32 and the other end connected to the other end 10B of the first coil 10 through the connection pattern 44. The number of turns of the third coil 30 is less than one.

As described above, the third coil 30 is connected to the end portion (the other end 10B) of the fourth section 14 of the first coil 10 that extends in the Y-direction and wound by about ¾ turn so as to protrude outward in the radial direction of the first coil 10 (i.e., in the positive X-direction). Therefore, the inside area of the third coil 30 partially surrounded by the conductor pattern of the third coil 30 is connected to the inside area of the first coil 10 partially surrounded by the conductor pattern of the first coil 10 through an area where the conductor pattern of the third coil 30 is absent.

Although the second coil 20 and third coil 30 differ from each other by 90° in the orientation of the conductor pattern, they may have the same line length and the same coil diameter.

The first coil 10 functions as an antenna coil for, for example, near-field communication (NFC) when the first and second pad electrodes 101 and 102 are connected with an external RFIC or the like. The conductor patterns of the first, second, and third coils 10, 20, and 30 which are connected in series between the first and second pad electrodes 101 and 102 may have a Q-value of, for example, 30 or more, a resistance value of 150 mΩ or less at 13.56 MHz, and a minimum effective current rating of 0.5 A or more.

The first coil 10 may be an antenna coil included in an NFC card or an antenna coil included in a card reader for communicating with the NFC card. The NFC uses a frequency of about 13.56 MHz. The second and third coils 20 and 30 each function as a sub coil for ensuring isolation from an unnecessary frequency component. Examples of the unnecessary frequency component include a frequency component used for Wi-Fi, a frequency component used for cellular, and a frequency component used for Bluetooth. Wi-Fi uses 2.4 GHz, 5 GHz, and 6 GHz frequency bands, for example. Cellular (sub6) uses a frequency range of 0.45 GHz to 7 GHz. Bluetooth uses a 2.4 GHz frequency band.

For example, the second and third coils 20 and 30 are each designed so as to have a high impedance in a frequency band (e.g., 1 GHz band) higher than the resonance frequency of the first coil 10. To achieve this, in the present embodiment, the line lengths of the second and third coils 20 and 30 are shorter than the line length of the first coil 10, and the coil diameters of the second and third coils 20 and 30 are smaller than the coil diameter of the first coil 10. In the present embodiment, the second and third coils 20 and 30 having such characteristics are connected respectively to both ends of the first coil 10, so that it is possible to ensure isolation from an unnecessary high frequency component without adding an electronic component such as a chip inductor. That is, the second and third coils 20 and 30 each have an inductive inductance (X_{L}) at the resonance frequency (e.g., 13.56 MHz) of a main coil (first coil 10) larger than a capacitive inductance (X_{C}) thereat, and thereby each can have a high impedance at a frequency band higher than the resonance frequency of the first coil 10.

Further, in the present embodiment, the first, second, and third coils 10, 20, and 30 are positioned on the same plane, and the inside areas of the second and third coils 20 and 30 do not overlap each other. This suppresses coupling between the second and third coils 20 and 30, allowing each of the second and third coils 20 and 30 to effectively function as a sub coil for ensuring isolation. In addition, the second and third coils 20 and 30 are wound so as to protrude outward in the radial direction of the first coil 10, thus further suppressing coupling between the second and third coils 20 and 30.

Further, in the present embodiment, the line length of the second coil 20 and that of the third coil 30 are equal to each other, and the coil diameter of the second coil 20 and that of the third coil 30 are equal to each other, thereby enhancing the symmetry of an antenna coil constituted of the first, second, and third coils 10, 20, and 30.

Further, in the present embodiment, the magnetic body 130 has the cutout area 133 so as to avoid overlapping with the second and third coils 20 and 30. This suppresses the inductances of the second and third coils 20 and 30, allowing a high impedance to be maintained in a high frequency band, which can further reduce the influence of an unnecessary high frequency component. Furthermore, in the present embodiment, the metal layer 140 has the clearance area 143 so as to avoid overlapping with the second and third coils 20 and 30, making it possible to prevent the occurrence of an eddy current caused due to application of magnetic flux generated by the second and third coils 20 and 30 to the metal layer 140.

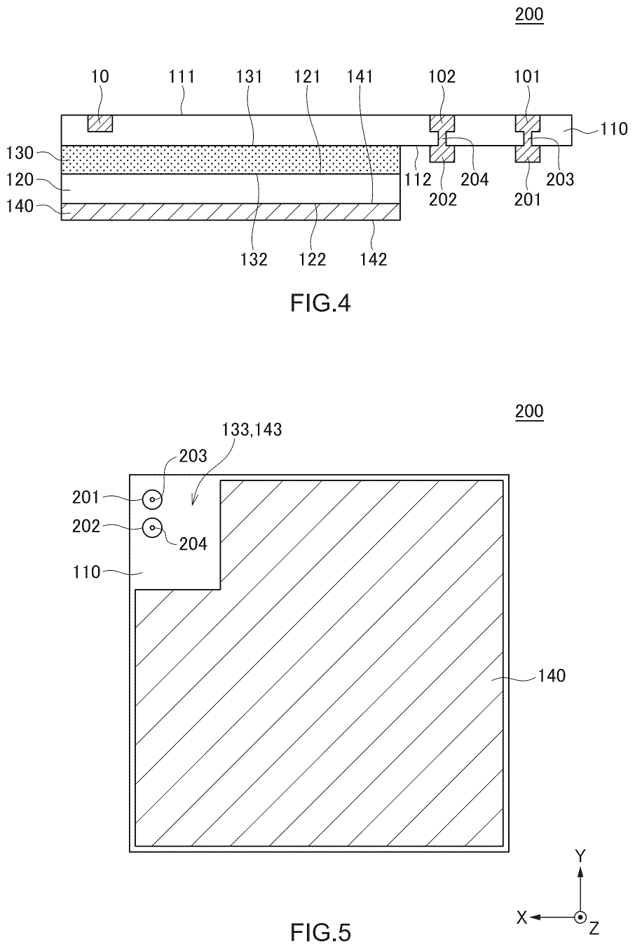

FIG. 4 is a schematic cross-sectional view of a coil component 200 according to a second embodiment of the technology described herein. The schematic plan view of the coil component 200 according to the second embodiment as viewed from one surface side thereof is the same as FIG. 1. The schematic plan view of the coil component 200 according to the second embodiment as viewed from the other surface side thereof is illustrated in FIG. 5.

As illustrated in FIGS. 4 and 5, the coil component 200 according to the second embodiment differs from the coil component 100 according to the first embodiment in that it additionally has a first pad electrode 201, a second pad electrode 202, a first connection conductor 203, and a second connection conductor 204. The first pad electrode 201, second pad electrode 202, first connection conductor 203, and second connection conductor 204 are all disposed so as to overlap the cutout area 133 of the magnetic body 130 and the clearance area 143 of the metal layer 140. Other basic configurations are the same as those of the coil component 100 according to the first embodiment, so the same reference numerals are given to the same elements, and overlapping description will be omitted.

The first and second pad electrodes 201 and 202 are disposed on the other surface 112 side of the first resin layer 110 so as to respectively overlap the first and second pad electrodes 101 and 102. The first pad electrode 101 and first pad electrode 201 are connected to each other through the first connection conductor 203 penetrating the first resin layer 110. The second pad electrode 102 and second pad electrode 202 are connected to each other through the second connection conductor 204 penetrating the first resin layer 110. This allows the coil component 200 according to the second embodiment to achieve electrical connection from both the positive and negative Z-direction sides.

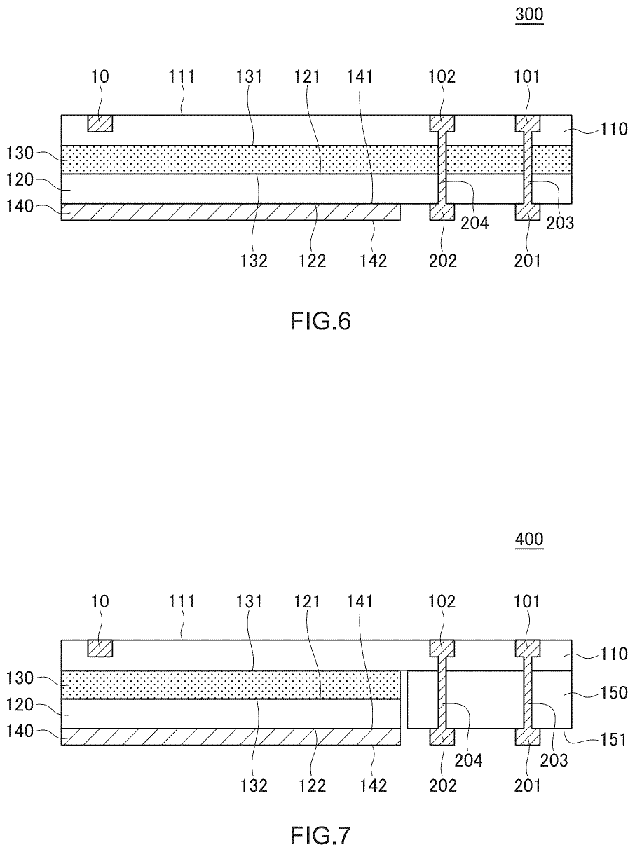

FIG. 6 is a schematic cross-sectional view of a coil component 300 according to a third embodiment of the technology described herein.

As illustrated in FIG. 6, the coil component 300 according to the third embodiment differs from the coil component 200 according to the second embodiment in that the magnetic body 130 does not have the cutout area 133 and that the other surface 112 of the first resin layer 110 are substantially entirely covered with the magnetic body 130 and second resin layer 120. The first and second pad electrodes 201 and 202 are both disposed on the other surface 122 side of the second resin layer 120, within the clearance area 143 of the metal layer 140. Other basic configurations are the same as those of the coil component 200 according to the second embodiment, so the same reference numerals are given to the same elements, and overlapping description will be omitted.

The first and second pad electrodes 201 and 202 are disposed on the other surface 122 side of the second resin layer 120 so as to respectively overlap the first and second pad electrodes 101 and 102. The first pad electrode 101 and first pad electrode 201 are connected to each other through the first connection conductor 203 penetrating the first resin layer 110, magnetic body 130, and second resin layer 120. The second pad electrode 102 and second pad electrode 202 are connected to each other through the second connection conductor 204 penetrating the first resin layer 110, magnetic body 130, and second resin layer 120. Thus, in addition to the effect obtained in the second embodiment, it is possible to facilitate manufacturing due to unnecessity of forming the cutout area in the second resin layer 120 and magnetic body 130. In addition, the first and second pad electrodes 201 and 202 can be disposed on substantially the same plane as the metal layer 140.

FIG. 7 is a schematic cross-sectional view of a coil component 400 according to a fourth embodiment of the technology described herein.

As illustrated in FIG. 7, the coil component 400 according to the fourth embodiment differs from the coil component 200 according to the second embodiment in that a spacer layer 150 is provided within the cutout area 133 of the magnetic body 130 and the clearance area 143 of the metal layer 140. The first and second pad electrodes 201 and 202 are both disposed on a surface 151 of the spacer layer 150. Other basic configurations are the same as those of the coil component 200 according to the second embodiment, so the same reference numerals are given to the same elements, and overlapping description will be omitted.

The first and second pad electrodes 201 and 202 are disposed on the surface 151 side of the spacer layer 150 so as to respectively overlap the first and second pad electrodes 101 and 102. The first pad electrode 101 and first pad electrode 201 are connected to each other through the first connection conductor 203 penetrating the first resin layer 110 and spacer layer 150. The second pad electrode 102 and second pad electrode 202 are connected to each other through the second connection conductor 204 penetrating the first resin layer 110 and spacer layer 150. Thus, in the coil component 400 according to the fourth embodiment, it is possible to dispose the first and second pad electrodes 201 and 202 on substantially the same plane as the metal layer 140 without necessity of providing the magnetic body 130 at a position overlapping the second and third coils 20 and 30.

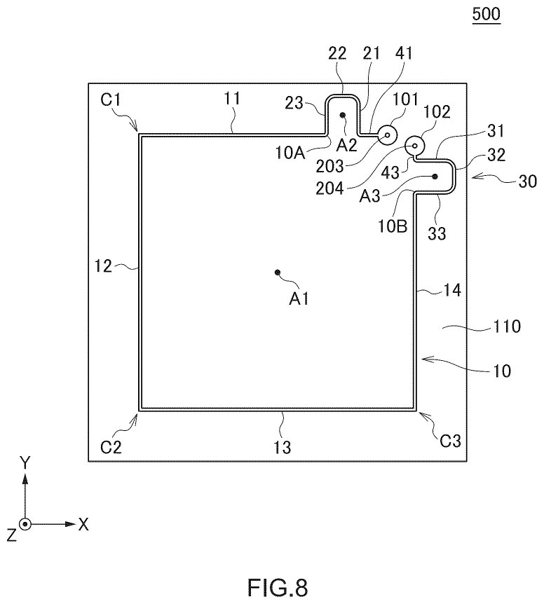

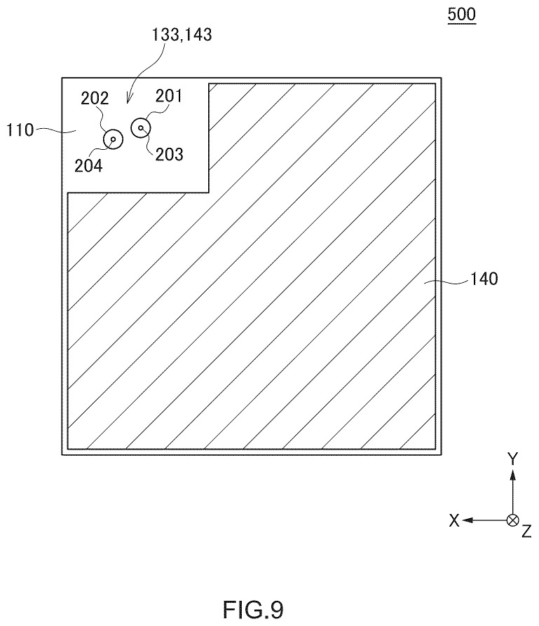

FIGS. 8 and 9 are schematic plan views each illustrating the outer appearance of a coil component 500 according to a fifth embodiment of the technology described herein, which illustrate the structure as viewed from the opposite sides.

As illustrated in FIGS. 8 and 9, the coil component 500 according to the fifth embodiment differs from the coil component 200 according to the second embodiment in that the second coil 20 is connected to the one end 10A of the first coil 10 without through the connection pattern 42 and that the third coil 30 is connected to the other end 10B of the first coil 10 without through the connection pattern 44. Other basic configurations are the same as those of the coil component 200 according to the second embodiment, so the same reference numerals are given to the same elements, and overlapping description will be omitted.

As exemplified in the fifth embodiment, the first coil 10 may be connected directly to the second and third coils 20 and 30. This makes designing easy due to absence of the connection pattern which may affect frequency characteristics.

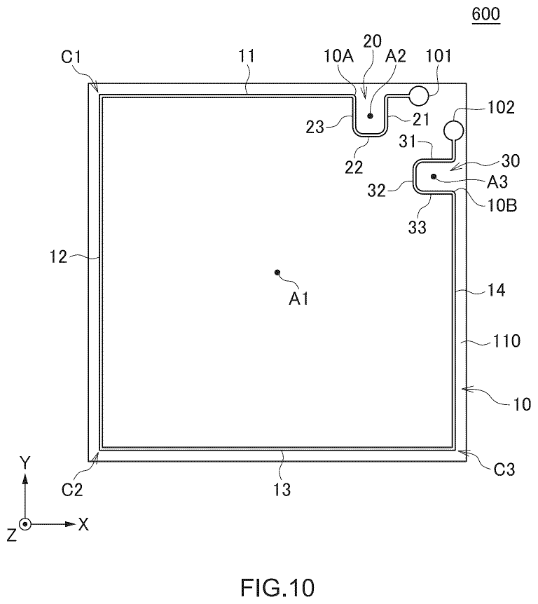

FIG. 10 is a schematic plan view illustrating the outer appearance of a coil component 600 according to a sixth embodiment of the technology described herein.

As illustrated in FIG. 10, the coil component 600 according to the sixth embodiment differs from the coil component 500 according to the fifth embodiment in that the second coil 20 is wound by about ¾ turn so as to protrude inward in the radial direction of the first coil 10 (i.e., in the negative Y-direction), and the third coil 30 is wound by about ¾ turn so as to protrude inward in the radial direction of the first coil 10 (i.e., in the negative X-direction). Other basic configurations are the same as those of the coil component 500 according to the fifth embodiment, so the same reference numerals are given to the same elements, and overlapping description will be omitted.

As exemplified in the sixth embodiment, the second and third coils 20 and 30 may be wound so as to protrude inward in the radial direction of the first coil 10. Alternatively, a configuration may be possible in which one of the second and third coils 20 and 30 is wound so as to protrude outward in the radial direction of the first coil 10, and the other one thereof is wound so as to protrude inward in the radial direction of the first coil 10.

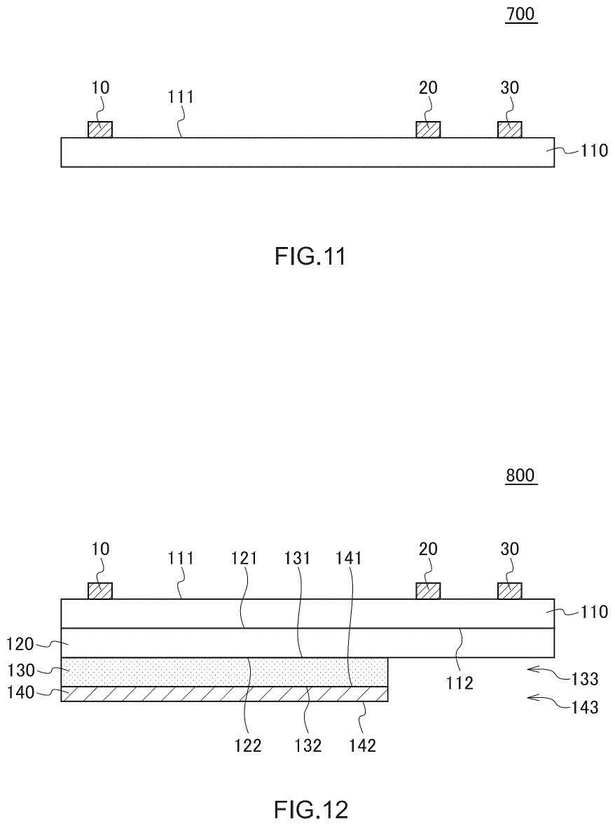

FIG. 11 is a schematic cross-sectional view of a coil component 700 according to a seventh embodiment of the technology described herein.

As illustrated in FIG. 11, the coil component 700 according to the seventh embodiment differs from the coil component 100 according to the first embodiment in that the first, second, and third coils 10, 20, and 30 are all provided on the one surface 111 of the first resin layer 110 and that the second resin layer 120, magnetic body 130, and metal layer 140 are omitted. Other basic configurations are the same as those of the coil component 100 according to the first embodiment, so the same reference numerals are given to the same elements, and overlapping description will be omitted.

As exemplified in the seventh embodiment, the first, second, and third coils 10, 20, and 30 need not necessarily be embedded in the first resin layer 110 but may be provided on the one surface 111 of the first resin layer 110. In this case, polyethylene terephthalate (PET) resin, polycarbonate (PC) resin, polyimide (PI) resin, and the like may be used as the material of the first resin layer 110. Further, the second resin layer 120, magnetic body 130, and metal layer 140 need not necessarily be provided and may be omitted.

FIG. 12 is a schematic cross-sectional view of a coil component 800 according to an eighth embodiment of the technology described herein.

As illustrated in FIG. 12, the coil component 800 according to the eighth embodiment differs from the coil component 100 according to the first embodiment in that the first, second, and third coils 10, 20, and 30 are provided on the one surface 111 of the first resin layer 110 and that the positions of the second resin layer 120 and magnetic body 130 are reverse to those in the first embodiment. Other basic configurations are the same as those of the coil component 100 according to the first embodiment, so the same reference numerals are given to the same elements, and overlapping description will be omitted.

As exemplified in the eighth embodiment, the second resin layer 120 may be positioned between the first resin layer 110 and the magnetic body 130. In this case, the other surface 112 of the first resin layer 110 may be covered entirely with the second resin layer 120.

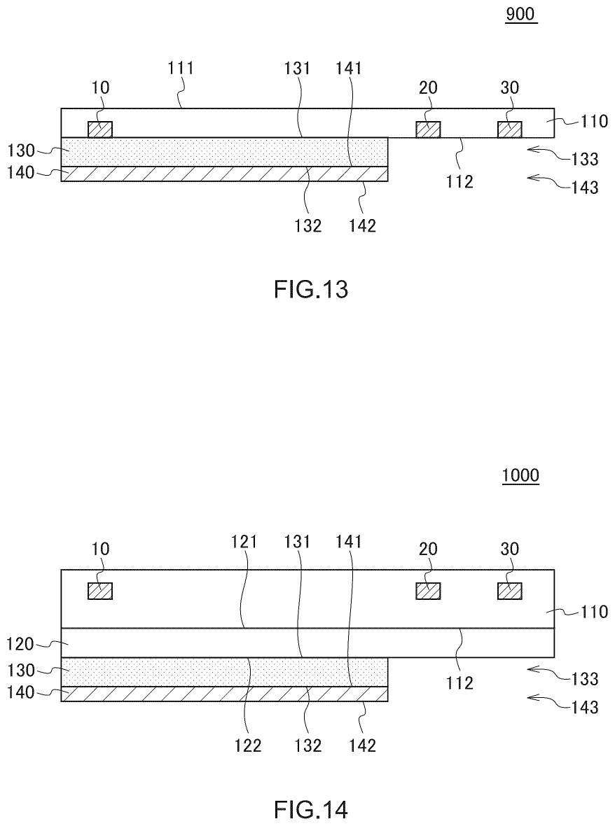

FIG. 13 is a schematic cross-sectional view of a coil component 900 according to a ninth embodiment of the technology described herein.

As illustrated in FIG. 13, the coil component 900 according to the ninth embodiment differs from the coil component 100 according to the first embodiment in that the first, second, and third coils 10, 20, and 30 embedded in the first resin layer 110 are exposed from the other surface 112 side of the first resin layer 110 and that the second Other basic resin layer 120 is omitted. Other basic configurations are the same as those of the coil component 100 according to the first embodiment, so the same reference numerals are given to the same elements, and overlapping description will be omitted.

As exemplified in the ninth embodiment, the first, second, and third coils 10, 20, and 30 embedded in the first resin layer 110 may be exposed from the other surface 112 side of the first resin layer 110.

FIG. 14 is a schematic cross-sectional view of a coil component 1000 according to a tenth embodiment of the technology described herein.

As illustrated in FIG. 14, the coil component 1000 according to the tenth embodiment differs from the coil component 800 according to the eighth embodiment in that the first, second, and third coils 10, 20, and 30 are embedded in the first resin layer 110 without being exposed from the one and the other surfaces 111 and 112. Other basic configurations are the same as those of the coil component 800 according to the eighth embodiment, so the same reference numerals are given to the same elements, and overlapping description will be omitted.

As exemplified in the tenth embodiment, the first, second, and third coils 10, 20, and 30 may be embedded completely in the first resin layer 110.

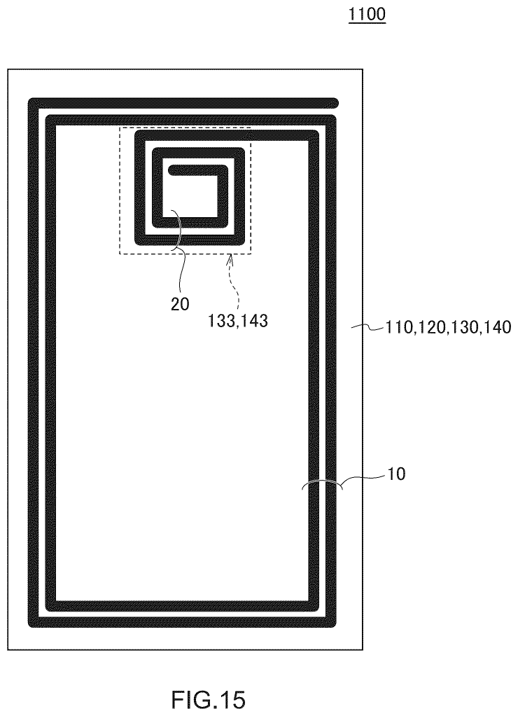

FIG. 15 is a schematic plan view illustrating the outer appearance of a coil component 1100 according to an eleventh embodiment of the technology described herein.

As illustrated in FIG. 15, the coil component 1100 according to the eleventh embodiment differs from the coil component 100 according to the first embodiment in that the first and second coils 10 and 20 each have about two turns and that the third coil 30 is omitted. Other basic configurations are the same as those of the coil component 100 according to the first embodiment, so the same reference numerals are given to the same elements, and overlapping description will be omitted.

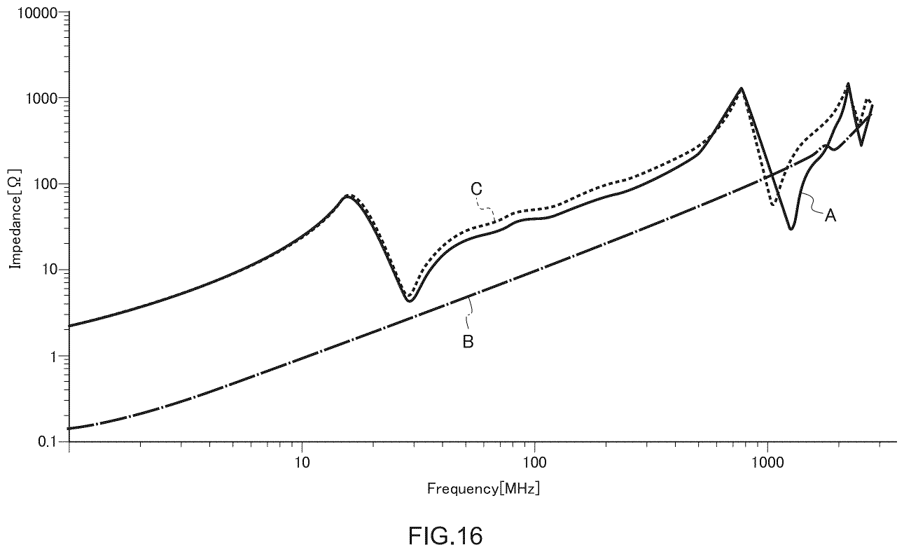

FIG. 16 is a graph illustrating the characteristics of the coil component 1100 according to the eleventh embodiment, in which the curve A denotes the impedance of the first coil 10, the curve B denotes the impedance of the second coil 20, and the curve C denotes the combined impedance of the first and second coils 10 and 20.

As can be seen from the graph of FIG. 16, adding the second coil 20 to the first coil 10 increases the impedance in a frequency band equal to or higher than 30 MHz as compared with when only the first coil 10 is provided. On the other hand, in a frequency band less than 30 MHz, adding the second coil 20 causes almost no impedance change.

As exemplified in the eleventh embodiment, the number of turns of each of the first and second coils 10 and 20 is not particularly limited. Further, the third coil 30 need not necessarily be connected to the first coil 10 but may be omitted.

While some embodiments of the technology according to the present disclosure have been described, the technology according to the present disclosure is not limited to the above embodiments, and various modifications may be made within the scope of the present disclosure, and all such modifications are included in the technology according to the present disclosure.

The technology according to the present disclosure includes the following configuration examples, but not limited thereto.

For example, the second and third coils 20 and 30 are each disposed near the corner of the first resin layer 110 in a plan view in the above embodiments; however, this is not essential, but the plane positions of the second and third coils 20 and 30 are not particularly limited.

Further, the metal layer 140 has the clearance area 143 in the above embodiments; however, this is also not essential. For example, instead of providing the clearance area 143 in the metal layer 140, a mesh-like conductor pattern may be disposed in an area corresponding to the clearance area 143. This reduces a stray capacitance as compared with when the clearance area 143 is provided.

Further, the first coil 10 functions as an antenna coil for NFC in the above embodiments; however, it may be applied to any system having a resonance frequency of, for example, 40 MHz or less. Specifically, for example, the first coil 10 can be used as a resonance coil for wireless power transmission.

A coil component according to an aspect of the present disclosure includes: a first coil wound about a first coil axis; a second coil having one end connected to one end of the first coil and wound about a second coil axis; and a third coil having one end connected to the other end of the first coil and wound about a third coil axis. The line lengths of both the second and third coils are shorter than the line length of the first coil, and the inside area of the second coil is positioned outside the inside area of the third coil as viewed in the axial direction of the second coil. With this configuration, the second and third coils each function as a sub coil for ensuring isolation, thus making it possible to achieve isolation from an unnecessary frequency component.

In the above coil component, the numbers of turns of the first, second, and third coils may all be less than one. This facilitates connection between the first and second coils and between the first and third coils.

In the above coil component, the second and third coils may be wound so as to protrude in the radial direction of the first coil. This makes it possible to suppress coupling between the second and third coils while sufficiently ensuring the number of turns of the first coil. In this case, at least one of the second and third coils may be wound so as to protrude outward in the radial direction of the first coil. This can suppress coupling between the second and third coils more effectively. Further, in this case, both the second and third coils may be wound so as to protrude outward in the radial direction of the first coil. This can suppress coupling between the second and third coils even more effectively.

In the above coil component, the coil diameters of the second and third coils may be smaller than the coil diameter of the first coil. This can reduce the influence of an unnecessary frequency component higher than the resonance frequency of the first coil while maintaining the characteristics of the first coil.

In the above coil component, the first coil may include a first section extending in a first direction from one end of the first coil toward a first corner thereof, a second section extending in a second direction perpendicular to the first direction from the first corner of the first coil to a second corner thereof, a third section extending in the first direction from the second corner of the first coil toward the third corner thereof, and a fourth section extending in the second direction from the third corner of the first coil to the other end thereof. This can sufficiently ensure the area of the inside area surrounded by the first coil and sufficiently ensure the number of turns of the first coil.

In the above coil component, the first, second, and third coils may be positioned on the same plane. This can reduce the entire thickness of the coil component.

The coil component may further include a magnetic body that overlaps the first coil. This increases the inductance of the first coil.

In the above coil component, the second coil may overlap a first outside area positioned outside the outer peripheral edge of the magnetic body as viewed in the axial direction of the second coil axis, and the third coil may overlap the first outside area as viewed in the axial direction of the third coil axis. In other words, the magnetic body may have a cutout area so as to avoid overlapping with the second and third coils. This reduces the inductances of the second and third coils to make it possible to maintain a high impedance in a high frequency band, thus further reduce the influence of an unnecessary high frequency component.

The above coil component may further include a metal layer that overlaps the magnetic body, and the magnetic body may be positioned between the first coil and the metal layer. This can reduce the occurrence of an eddy current due to magnetic flux generated from the first coil.

In the above coil component, the second coil may overlap a second outside area positioned outside the outer peripheral edge of the metal layer as viewed in the axial direction of the second coil axis, and the third coil may overlap the second outside area as viewed in the axial direction of the third coil axis. In other words, the metal layer may have a clearance area so as to avoid overlapping with the second and third coils. This can reduce the occurrence of an eddy current due to magnetic flux generated from the second and third coils.

The above coil component may further include first and second pad electrodes disposed in the second outside area. The first pad electrode and the other end of the second coil may be connected to each other through a first connection conductor penetrating the magnetic body, and the second pad electrode and the other end of the third coil may be connected to each other through a second connection conductor penetrating the magnetic body. This allows a series circuit composed of the first, second, and third coils to be connected from the magnetic body side.

The above coil component may further include a first resin layer positioned between the first, second, and third coils and the magnetic body, and the first, second, and third coils may be embedded at least partially in the first resin layer. This can enhance flatness of the surface of the coil component and reduce the entire thickness of the coil component.

The above coil component may further include a second resin layer positioned between the magnetic body and the metal layer. This can fix the magnetic body and metal layer through the second resin layer.

In the above coil component, the first and second resin layers may contain inorganic filler particles. This increases the strength of the first and second resin layers.

The coil component according to the present disclosure further has the following characteristics.
1. A loop antenna (inductor) comprising:
an antenna conductor formed of a high conductive material;
a structure for supporting the antenna conductor, the structure formed of a film material or suspended in a non-magnetic binding resin material; and
optionally, a magnetic shield layer attached to at least one of the antenna conductor and the structure, the magnetic shield layer having optional selective cutout or recess adjacent the antenna conductor to achieve a pre-determined target inductance, self-resonant frequency (SRF) and Quality Factor (Q) value.
2. The loop antenna of claim 1, wherein the high conductive material is at least one of copper, aluminum or other low resistance materials.
3. The loop antenna of claim 1, wherein the film material is at least one of polyethylene terephthalate (PET), polycarbonate (PC), polyimide (PI), or other polymeric material or an acrylic (or other) non-magnetic based binding resin substrate used as an embedding and bonding layer.
4. The loop antenna of claim 1, wherein the combination of pattern, design and material of the loop antenna yields a Q value of at least about 15, or at least about 20, or at least about 30.
5. The loop antenna of claim 1, wherein the SRF can maintain inductance reactance (XL) greater than capacitance reactance (XC) to ensure inductive properties and yield high impedance in sub-6 GHz cellular frequencies.
6. The loop antenna of claim 1 having a minimum root mean square (RMS) current rating of at least about 0.5 Amp-RMS and low series impedance (/z/) at about 13.56 MHz of less than about 300 mOhms.
7. A series-isolation inductor comprising:
an inductor conductor formed of a high conductive material;
a structure for supporting the inductor conductor, the structure formed of at least one of polyethylene terephthalate (PET), polycarbonate (PC), polyimide (PI), or other polymeric material, or suspended in a non-magnetic binding resin material; and
optionally, a magnetic shield layer attached to at least one of the inductor conductor and the structure, the magnetic shield layer having optional selective cutout or recess adjacent the inductor conductor to achieve a pre-determined target inductance, self-resonant frequency (SRF) and Quality Factor (Q) value.
8. The series-isolation inductor of claim 7, wherein the high conductive material is at least one of copper, aluminum or other low resistance materials.
9. The series-isolation inductor of claim 7, wherein the non-magnetic binding resin material is an acrylic (or other) nonmagnetic based binding resin substrate used as an embedding and bonding layer.
10. The series-isolation inductor of claim 7, wherein the combination of pattern, design and material of the series-isolation inductor yields a Q value of at least about 15, or at least about 20, or at least about 30.
11. The series-isolation inductor of claim 7, wherein the SRF can maintain inductance reactance (XL) greater than capacitance reactance (XC) to ensure inductive properties and yield high impedance in sub-6 GHz cellular frequencies.
12. The series-isolation inductor of claim 7 having a minimum root mean square (RMS) current rating of at least about 0.5 Amp-RMS and low series impedance (/z/) at about 13.56 MHz of less than about 300 mOhms.
13. A system comprising:
a near field communication (NFC) or wireless power antenna having:
an optional carrier film or non-magnetic binding resin;
an optional magnetic shield layer; and
a series-integrated inductor(s) structure manufactured in substantially similar manner using substantially similar materials, processes and manufacturing techniques, and in tandem with the fabrication of the NFC or wireless power antenna, to achieve a predetermined target inductance, self-resonant frequency (SRF) and Quality Factor (Q) value.
14. The system of claim 13, wherein the NFC or wireless power antenna has a planar loop pattern.
15. The system of claim 13, wherein the combination of pattern, design and material of the NFC or wireless power antenna yields a Q value of at least about 15, or at least about 20, or at least about 30.
16. The system of claim 13, wherein the SRF can maintain inductance reactance (XL) greater than capacitance reactance (XC) to ensure inductive properties and yield high impedance in sub-6 GHz cellular frequencies.
17. The system of claim 13, wherein the NFC or wireless power antenna has a minimum root mean square (RMS) current rating of at least about 0.5 Amp-RMS and low series impedance (/z/) at about 13.56 MHz of less than about 300 mOhms.
18. A method comprising:
providing at least one of a wireless fidelity (WiFi), Bluetooth (BT) and cellular-blocking series inductor(s) structure integrated onto at least one of a near field communication (NFC) or wireless power antenna, the cellular-blocking series inductor(s) structure manufactured in substantially similar manner using substantially similar materials, processes and manufacturing techniques, and in tandem with the fabrication of the NFC or wireless power antenna and optionally with at least one of a carrier film or acrylic (or other) non-magnetic based binding resin substrate, without requiring any additional area or volume than that of an NFC or wireless power antenna without the cellular-blocking series inductor(s) structure.
19. The method of claim 18, wherein the providing step includes:
forming a conductor, wherein the conductor is a high conductive material;
forming a structure for supporting the conductor; and
forming an optional magnetic shield layer attached to at least one of the conductor and the structure to achieve a pre-determined target inductance, self-resonant frequency (SRF) and Quality Factor (Q) value of the NFC or wireless power antenna.
20. The method of claim 19, wherein the forming the optional magnetic shield layer step includes providing selective cutout or recess in the optional magnetic shield layer adjacent to the conductor.

What is claimed is:

1. A coil component comprising:
a first coil wound about a first coil axis;
a second coil having one end connected to one end of the first coil and wound about a second coil axis; and
a third coil having one end connected to other end of the first coil and wound about a third coil axis,
wherein line lengths of both the second and third coils are shorter than a line length of the first coil, and
wherein an inside area of the second coil is positioned outside an inside area of the third coil as viewed in an axial direction of the second coil.

2. The coil component as claimed in claim 1, wherein a number of turns of each of the first, second, and third coils is less than one.

3. The coil component as claimed in claim 2, wherein the second and third coils are wound so as to protrude in a radial direction of the first coil.

4. The coil component as claimed in claim 3, wherein at least one of the second and third coils is wound so as to protrude outward in the radial direction of the first coil.

5. The coil component as claimed in claim 4, wherein both the second and third coils are wound so as to protrude outward in the radial direction of the first coil.

6. The coil component as claimed in claim 1, wherein coil diameters of the second and third coils are smaller than a coil diameter of the first coil.

7. The coil component as claimed in claim 1, wherein the first coil includes a first section extending in a first direction from the one end of the first coil toward a first corner thereof, a second section extending in a second direction perpendicular to the first direction from the first corner of the first coil to a second corner thereof, a third section extending in the first direction from the second corner of the first coil toward the third corner thereof, and a fourth section extending in the second direction from the third corner of the first coil to the other end thereof.

8. The coil component as claimed in claim 1, wherein the first, second, and third coils are positioned on a same plane.

9. The coil component as claimed in claim 1, further comprising a magnetic body that overlaps the first coil.

10. The coil component as claimed in claim 9,
wherein the second coil overlaps a first outside area positioned outside an outer peripheral edge of the magnetic body as viewed in the axial direction of the second coil axis, and
wherein the third coil overlaps the first outside area as viewed in an axial direction of the third coil axis.

11. The coil component as claimed in claim 9, further comprising a metal layer that overlaps the magnetic body,
wherein the magnetic body is positioned between the first coil and the metal layer.

12. The coil component as claimed in claim 11,
wherein the second coil overlaps a second outside area positioned outside an outer peripheral edge of the metal layer as viewed in the axial direction of the second coil axis, and
wherein the third coil overlaps the second outside area as viewed in an axial direction of the third coil axis.

13. The coil component as claimed in claim 12, further comprising first and second pad electrodes disposed in the second outside area,
wherein the first pad electrode and other end of the second coil are connected to each other through a first connection conductor penetrating the magnetic body, and
wherein the second pad electrode and other end of the third coil are connected to each other through a second connection conductor penetrating the magnetic body.

14. The coil component as claimed in claim 9, further comprising a first resin layer positioned between the first, second, and third coils and the magnetic body,
wherein the first, second, and third coils are embedded at least partially in the first resin layer.

15. The coil component as claimed in claim 14, further comprising a second resin layer positioned between the magnetic body and the metal layer.

16. The coil component as claimed in claim 15, wherein the first and second resin layers contain inorganic filler particles.

17. A coil component comprising:
a main coil wound about a first coil axis; and
a first sub coil connected to the main coil and having a higher impedance than the main coil at a frequency in a frequency band higher than a self-resonant frequency of the main coil.

18. The coil component as claimed in claim 17, further comprising a second sub coil connected to the main coil and having a higher impedance than the main coil at a frequency in a frequency band higher than a self-resonant frequency of the main coil,
wherein the first sub coil is connected to one end of the main coil, and
wherein the second sub coil is connected to other end of the main coil.

19. A coil component comprising:
a main coil having a self-resonant frequency at a first frequency; and
a first sub coil connected to the main coil and having an inductive inductance (XL) greater than a capacitive inductance (XC) in a second frequency band higher than the first frequency.

20. The coil component as claimed in claim 19, further comprising a second sub coil connected to the main coil and having an inductive inductance (XL) greater than a capacitive inductance (XC) in the second frequency band,
wherein the first sub coil is connected to one end of the main coil, and
wherein the second sub coil is connected to other end of the main coil.
